(19) United States
(12) Patent Application Publication
(10) Pub. No.: US 2022/0122196 A1
(43) Pub. Date: Apr. 21, 2022

(54) Method for Facilitating Venue-mediated Social Interactions

(71) Applicant: BDI&c LLC, Fort Lauderdale, FL (US)

(72) Inventor: John Mack, Fort Lauderdale, FL (US)

(21) Appl. No.: 17/504,290

(22) Filed: Oct. 18, 2021

Related U.S. Application Data
(60) Provisional application No. 63/092,904, filed on Oct. 16, 2020.

(51) Int. Cl. G06Q 50/00; G06Q 30/02; G06Q 30/06; H04W 4/021

(52) U.S. Cl. CPC G06Q 50/01; G06Q 30/0205; G06Q 30/0222; G06F 3/011; G06Q 30/0643; G06Q 30/0633; H04W 4/021; G06Q 30/0224

(57) ABSTRACT

A method for facilitating venue-mediated social interactions has a group of user accounts that are associated with a computing device and a remote server. The method provides a set of activity modes, a set of user interaction processes, and a set of geofenced activity zones. A local user is prompted to select a desired activity mode and then the method gathers raw environmental data to form a curated user group of remote users that align with the local user's location and preferences. After the curated group is created, the user is prompted to carry out one of the user interaction processes. Thereby enabling the local user to view and interact with a receptive group of remote users who happen to be within a given geofenced activity zone. The users are able to send and receive vendor services and messages in an attempt to initiate positive social interactions

The current application claims a priority to the U.S. Provisional Patent application Ser. No. 63/092,904 filed on Oct. 16, 2020. The current application is filed on Oct. 18, 2021 while Oct. 16, 2021 was on a weekend.

### FIELD OF THE INVENTION

The present disclosure relates generally to social media applications. More specifically, the present disclosure describes social media applications for facilitating social interactions.

### BACKGROUND OF THE INVENTION

Social media are interactive computer-mediated technologies that facilitate the creation or sharing of information, ideas, career interests and other forms of expression via virtual communities and network. This invention relieves the pressure and anxiety of attempting to meet a stranger in a bar or any social event. It is also useful for groups of peers to locate each other in a crowded venue. It serves a mobile application (connection app) for two (or more) people to engage each other using existing chat features, but also ties into the proprietor's system to allow for the purchase of drinks and food.

This can increase revenue for the venue and serve as an ice breaker for strangers.

### BRIEF DESCRIPTION OF THE DRAWINGS

Some of the embodiments will be described in detail, with reference to the following figures, wherein like designations denote like members, wherein:

FIG. 1 a block diagram of a social media application according to some embodiments.

FIG. 2 illustrates a flow chart of steps included in the social media application according to some embodiments.

FIG. 3 illustrates a flow chart of steps included for enabling the observer mode in the social media application according to some embodiments.

FIG. 4 illustrates a flow chart of steps included for enabling the participant mode in the social media application according to some embodiments.

FIG. 5 illustrates a flow chart of steps included for executing the user relations process in the social media application according to some embodiments.

FIG. 6 illustrates a flow chart of steps included for executing the vendor services process in the social media application according to some embodiments.

FIG. 7 illustrates a flow chart of steps included for prompting the vendor to deliver the vendor service after executing the vendor services process in the social media application according to some embodiments.

FIG. 8 illustrates a flow chart of steps included generating an interactive environment in the social media application according to some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

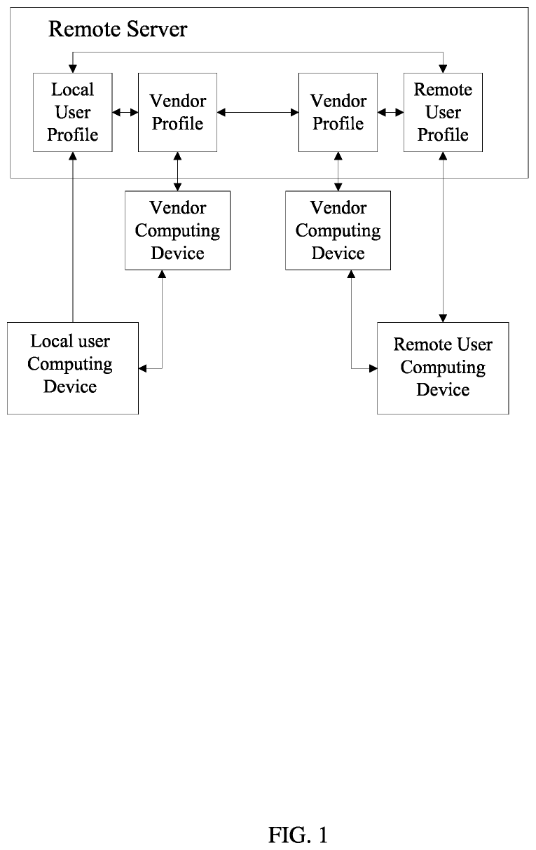

Referring to FIG. 1 through FIG. 8, the preferred embodiment of the present invention is a method for facilitating venue-mediated interactions. The present invention enables groups of users to communicate and transfer vendor services while in a venue. The present invention enables users to form or join groups with other users for the purpose of socializing and transferring vendor services. The method of the present invention enables an arbitrary local user to set their status whenever they enter a venue and then interact with or observe other users within the venue. This functionality enables the local user to approach other users who are open to meeting up or interacting. Thereby, removing the anxiety-inducing activities associated with an in-person introduction. In addition to facilitating social interactions, the method of the present invention is designed to provide a virtual space for users to congregate and purchase vendor services. Thus, the method of the present invention enables the local user to interact with a desired remote user in virtual reality VR, or augmented reality (AR), environments while sending real-world items to the remote user through the available vendor services. In one use case, the method of the present invention is used within a bar. The local user enters the bar and sets their status to participant. This status signifies that the local user is interested, or open to, interacting with other individuals employing the method of the present invention for social interactions. The method of the present invention provides the local user with a virtual representation of the bar and alerts the local user to the location and preferences of the other users. Depending on the preferences of the remote user, the local user is able to select any of the other users as the desired remote user and is able to perform a variety of activities selected from the group including, but not limited to, initiating a social interaction, browsing available profile data, and transferring vendor services.

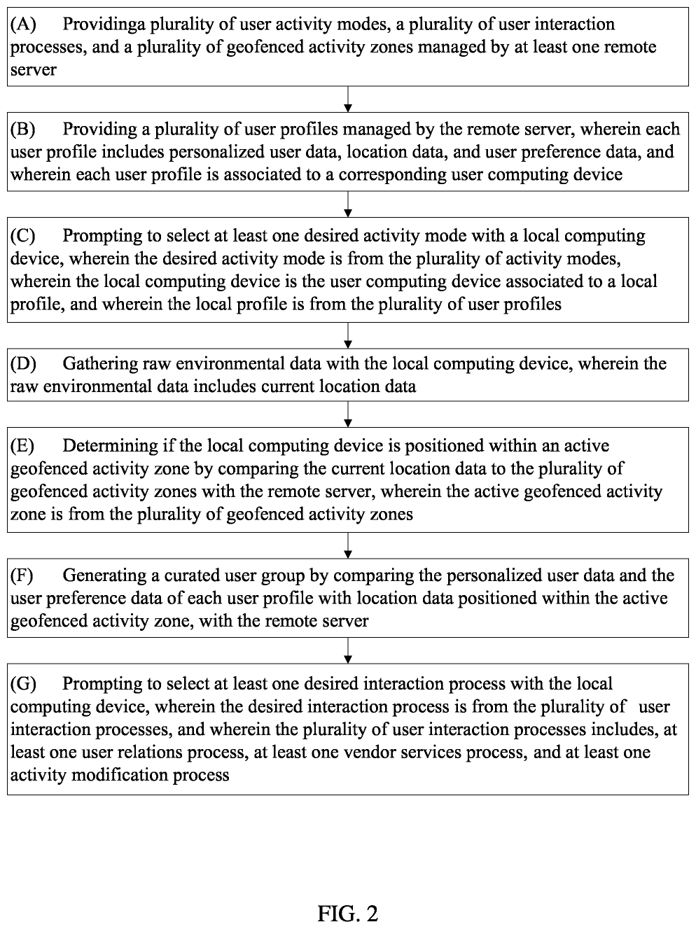

Referring to FIG. 1 and FIG. 2, to achieve the above-described functionality, the overall method of the present invention begins by providing a plurality of user activity modes, a plurality of user interaction processes, and a plurality of geofenced activity zones managed by at least one remote server (Step A). The plurality of activity modes refers to collections of routines that are executed to govern how the local user is able to interact with the method of the present invention. The plurality of user interaction processes refers to collections of routines that are executed to govern how the local user is able to interact with other users of the method of the present invention. The plurality of geofenced activity zones refers to virtual representations of the physical locations of venues and vendors managed by the method of the present invention. The term “remote server” is used herein to refer to a computing system capable of executing all background processes required to perform the method of the present invention. Additionally, the remote server is designed to coordinate the communication between a plurality of user computing devices and a plurality of vendor accounts. This integration with vendor accounts enables the present invention to function as an infotainment system where the user is able to view advertisements, explore virtual worlds, and navigate through brick-and-mortar venues. To interact with the VR or AR content while in the geofenced activity zones, the user simply points the camera lens of a capably equipped computing device at a desired area of the external environment, and the appropriate AR content will be overlaid onto the image of the real world being output by the display device of the user computing device. The user is then able to interact with the AR content using a plurality of commands including, but not limited to, moving physical objects into the space occupied by the AR content, scanning AR objects with the camera, or issuing verbal commands. In some embodiments the term “geofenced activity zone” refers to virtual locations that have no corresponding physical location.

Referring to FIG. 1 and FIG. 2, the overall method of the present invention continues by providing a plurality of user profiles managed by the remote server (Step B). Each of the plurality of user profiles is a virtual representation of a specific user and is associated to a corresponding user computing device. The term “computing device” is used herein to refer to any electronic system capable of executing the method of the present invention and communicating with external devices. In some embodiments, the user employs computing devices selected from the group comprising, smart phones, smart glasses, tablet computers, and laptop computers. To achieve this functionality, the present invention may employ an offloaded computing strategy that makes use of a user computing device as a front-end interface for user input and information gathering, and at least one remote server as the primary processing component. Thus, the present invention is able to provide a lightweight suite of socializing tools that can be integrated into web browsers and various other applications without requiring a significant amount of local processing power to be present in the user computing device. Further, each user profile includes personalized user data, location data, and user preference data. The personalized user data is a collection of user information relating to details selected from the group comprising demographic information, health information, education, dating history, and criminal record. The location data is related to the user's current location and location history. In some embodiments, the location data includes blacklisted locations and whitelisted locations. Thus, the user can be blocked from employing the method of the present invention to socialize in specific locations. The user preference data is a collection of settings the local user specifies to govern interactions with other users.

Referring to FIG. 1 and FIG. 2, the overall method of the present invention continues by prompting to select at least one desired activity mode with a local computing device (Step C). In the overall method of the present invention, the local computing device is the user computing device associated to a local profile, and the local profile is from the plurality of user profiles. Specifically, the local profile is the unique user profile for the arbitrary local user. The desired activity mode is from the plurality of activity modes and enables the local user to specify whether they want to interact with the present invention in various roles selected from the group comprising an observer, a participant, a vendor, and an administrator.

Referring to FIG. 1 and FIG. 2, the overall method of the present invention continues by gathering raw environmental data with the local computing device (Step D). The raw environmental data includes relevant datapoints about the environment external to the local user selected from the group comprising current location data, temperature date, proximity data, and wireless communication signal data. The overall method of the present invention continues by determining if the local computing device is positioned within an active geofenced activity zone by comparing the current location data to the plurality of geofenced activity zones with the remote server (Step E). The overall method of the present invention enables geofenced activity zones to be considered active and inactive. These states may correspond to times when the venue is closed, or times when the venue is offering special events or promotions. While in the active geofenced activity zone, the local user is presented with an interface that facilitates social interactions and purchasing of vendor services.

Referring to FIG. 1 and FIG. 2, the overall method of the present invention continues by generating a curated user group by comparing the personalized user data and the user preference data of each user profile with location data positioned within the active geofenced activity zone, with the remote server (Step F). The present invention is designed to enable multiple groups of users to inhabit the same venue while prohibiting overlap between conversations between each group. The curated user group is a collection of users who are within the active geofenced activity zone and who are matched to the local user based on the user preference data which includes datasets selected from the group comprising sexual orientation, likes, dislikes, relationship status, desired outcome of interaction, compatibility scores, and physical characteristics. Additionally, the local user may manually select the group or the composition of the group to be designated as the curated user group.

Referring to FIG. 1 and FIG. 2, the overall method of the present invention continues by prompting to select at least one desired interaction process with the local computing device (Step G), Specifically, the desired interaction process is from the plurality of user interaction processes and refers to subprocess of the method of the present invention that enables the local user to engage in a variety of activities with other users and vendors. Additionally, the plurality of user interaction process includes, at least one user relations process, at least one vendor services process, and at least one activity modification process. Thereby, facilitating socializing and vendor engagement. In one embodiment, the local user selects a remote profile that corresponds to the remote user from the plurality of user profiles within the curated user group. The local user then executes a series of desired interaction processes to select the remote user as a recipient of a proffered drink.

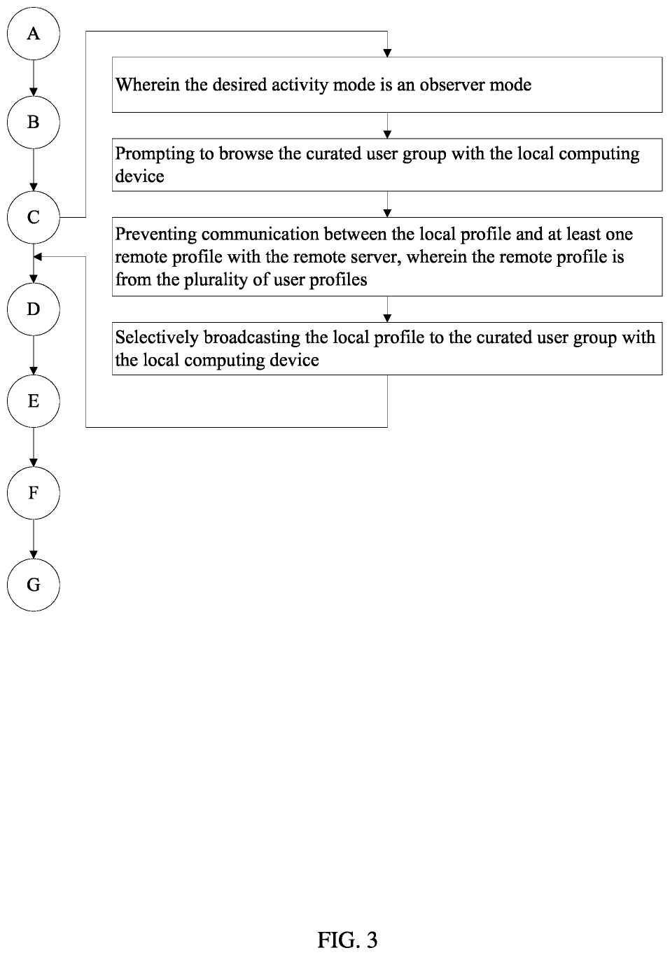

Referring to FIG. 3, the method of the present invention enables the local user to set the desired activity mode into an observer mode. The observer mode limits the interaction that the local user can have with vendors and other users. After the observer mode is set, a subprocess is executed to mediate the local user's interaction with the method of the present invention. This subprocess begins by prompting to browse the curated user group with the local computing device. The sub process continues by preventing communication between the local profile and the remote profile with the remote server. Accordingly, the local user is able to browse the user profiles of other users while in the observer mode. However, the local user is prevented from interacting with the other users. Specifically, the local user is able to set the desired interaction process to brose the user profiles of the curated user group but is prevented from setting the desired interaction process is send messages to the remote user. The local user remains able to engage with vendors and purchase vendor surfaces while in the observer mode. Additionally, the local user's current location and presence may be suppressed so that the local user's user profile does not appear in any curated user groups. The method of the present invention is designed to enable the local user to rapidly transition between activity modes. As such, the subprocess continues by selectively broadcasting the local profile to the curated user group with the local computing device. Specifically, the local user may be prompted to transition from the observer mode to a participant mode. While in the participant mode, the local user profile and location data are broadcast to other users. The local user is then prompted to change the activity mode and may choose to suppress their user profile by entering the observer mode once more.

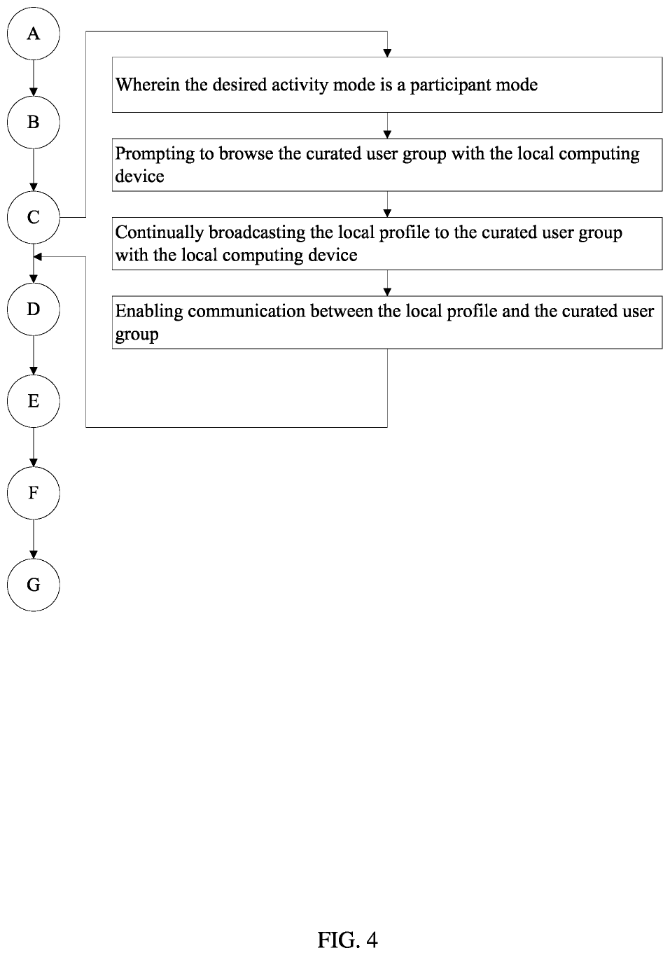

Referring to FIG. 4, the method of the present invention enables the local user to set the desired activity mode into the participant mode. The participant mode imposes few limits on the interaction that the local user can have with vendors and other users. After the participant mode is set, a subprocess is executed to mediate the local user's interaction with the method of the present invention. This subprocess begins by prompting to browse the curated user group with the local computing device. The sub process continues by continually broadcasting the local profile to the curated user group with the local computing device and enabling communication between the local profile and the remote profile with the remote server.

Accordingly, the local user is able to browse the user profiles of other users while in the participant mode. Additionally, the local user is able to interact with the other users. The local user remains able to engage with vendors and purchase vendor surfaces while in the participant mode. Additionally, the local user's current location and presence are broadcast so that the local user's user profile appears in curated user groups. Other users are able to interact with the local user and send messages or vendor services to the local user while in participant mode. The local user is able to set a visible status that denotes the activities the local user is currently engaging in or the types of users with whom local user is interested in interacting. In participant mode, the user is presented with options to perform tasks selected from the group comprising, checking in and out, creating new curated user groups, sending digital content, sending messages, adding or removing friends, creating and editing the personalized user data, and managing financial accounts. Further, the local user is given freedom to transition through the plurality of user activity modes. In some embodiments the local user sets the desired activity mode into an administrator mode. While in the administrator mode, the local user is granted the requisite permissions to manage and control every aspect of the method of the present invention.

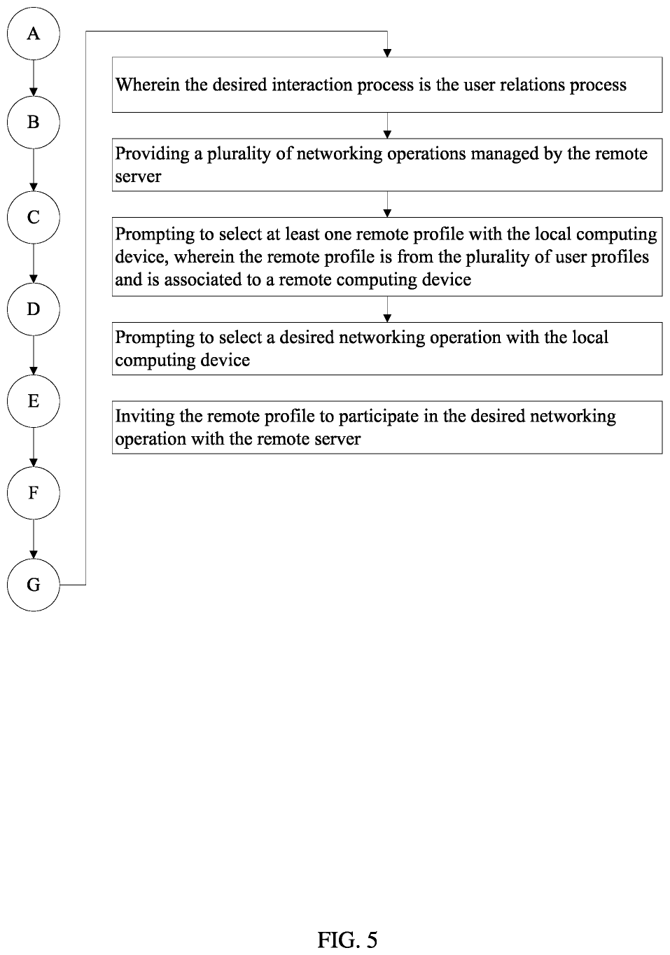

Referring to FIG. 5, the method of the present invention employs the plurality of user interaction processes to facilitate socializing between users. As such, the user relations process is executed when the local user sets the desired interaction process to facilitate socializing. The user relations process is a subprocess that begins by providing a plurality of networking operations that is managed by the remote server. Each network activity refers to a task or activity that the local user and the remote user can participate in. For example, the networking operation may be to send a message or a drink. The subprocess continues by prompting to select a desired networking operation with the local computing device and inviting the remote profile to participate in the desired networking operation with a remote computing device. Thus, the remote user is given the opportunity to accept the offer to socialize or to reject the offer. However, because the interaction was virtual, no awkward moment of personal rejection was experienced. The present invention can also be employed by groups of friends, or colleagues, to meet up while out. This enables each friend to know the other friend's location and status. Further, users may play geofenced games and engage with third-party vendor content through the method of the present invention.

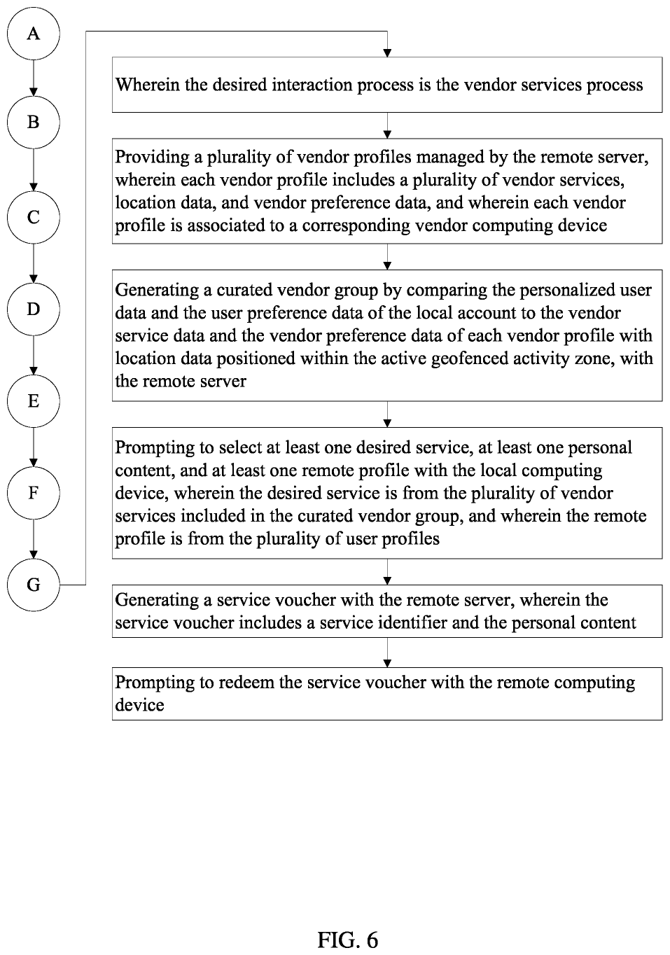

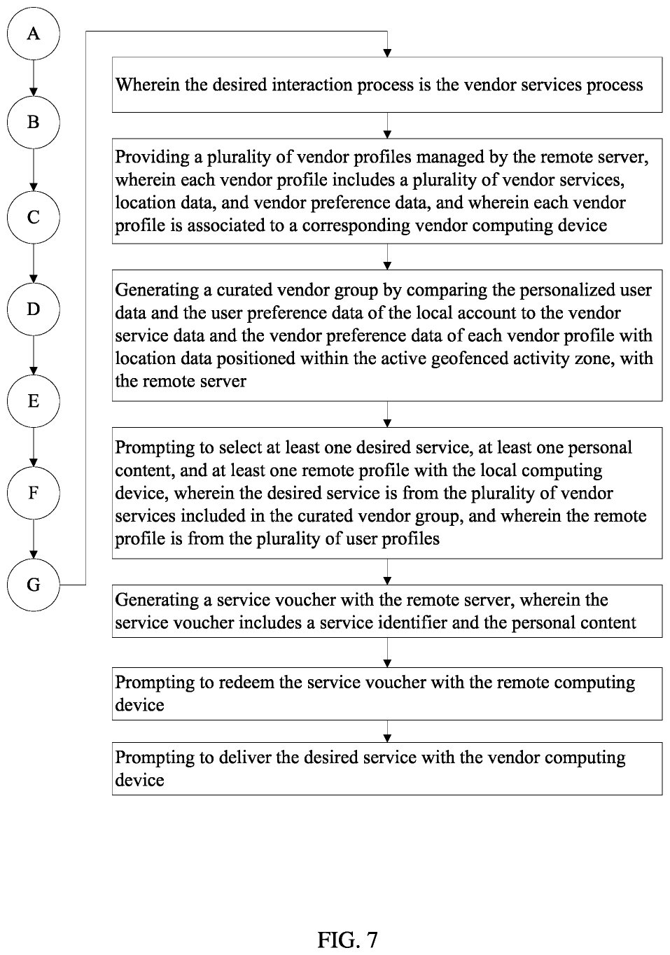

Referring to FIG. 6 and FIG. 7, the local user sets the desired interaction process to the vendor services process when they would like to purchase or engage with vendor services. The term “vendor services” is used herein to refer to various offerings from vendors including, but not limited to, food items, transportation, consumer goods, and financial management. The vendor services process begins by providing a plurality of vendor profiles managed by the remote server. Each vendor profile is a virtual representation of a vendor and is associated to a corresponding vendor computing device. Additionally, each vendor profile includes a plurality of vendor services, location data, and vendor preference data. The plurality of vendor services describes the offerings for each vendor. The vendor surfaces can be purchased by the local user or the remote user and transferred between users. The vendor services process continues by generating a curated vendor group by comparing the personalized user data and the user preference data of the local account to the vendor service data and the vendor preference data of each vendor profile with location data positioned within the active geofenced activity zone, with the remote server. Thus, the local user is only presented with relevant vendor profiles. The vendor services process continues by prompting to select at least one desired service, at least one personal content, and at least one remote profile with the local computing device, and generating a service voucher with the remote server. The desired service is chosen from the plurality of vendor services included in the curated vendor group. Additionally, the personal content is selected from the group comprising messages, images, videos, audio files, and virtual objects. The service voucher is a form of digital currency that can be exchanged for vendor services and includes a service identifier and the personal content. The vendor services process continues by prompting to redeem the service voucher with the remote computing device. Thus, the local user is able to notify the remote user that a drink has been purchased. It is then up to the remote user to redeem the drink or reject the offer. Each vendor profile is associated to a corresponding vendor computing device. The vendor can be further prompted to deliver the desired service through the vendor computing device.

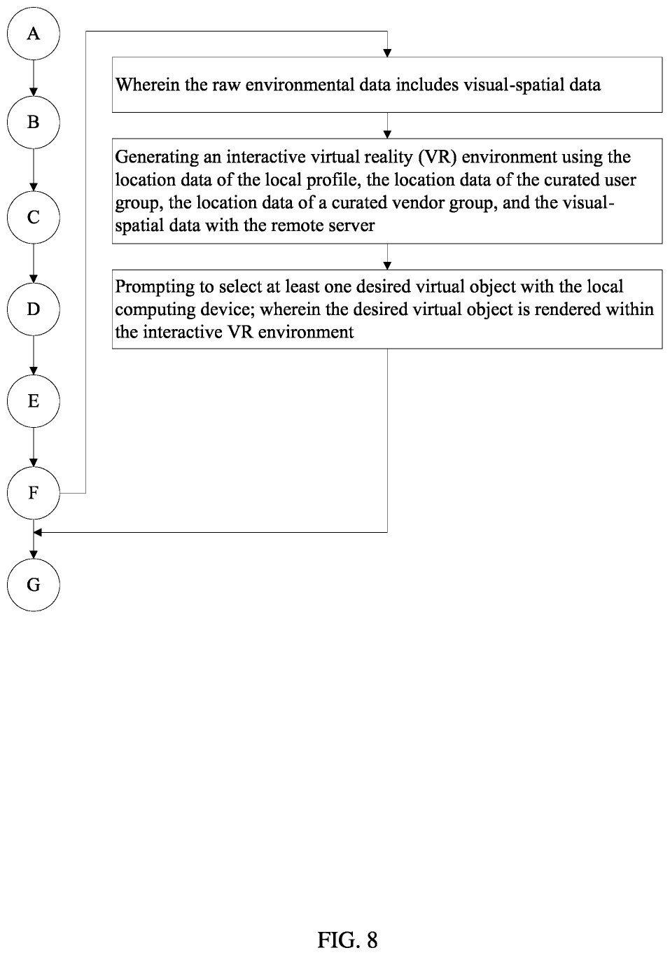

Referring to FIG. 8, in some embodiments, the present invention generates immersive environments for socializing. In these embodiments, the raw environmental data includes visual-spatial data. The method of the present invention is used for generating an interactive virtual reality (VR) environment using the location data of the local profile, the location data of the curated user group, the location data of a curated vendor group, and the visual-spatial data with the remote server. Additionally, the method of the present invention prompts to select at least one desired virtual object that is rendered within the interactive VR environment with the local computing device. Thus, the local user is able to enter a virtual world and interact with other users. Each user is given the option to create an avatar for their user profile.

Although the invention has been explained in relation to its preferred embodiment, it is to be understood that many other possible modifications and variations can be made without departing from the spirit and scope of the invention as hereinafter claimed.

What is claimed is:

1. A method for facilitating venue-mediated social interactions comprising:
(A) providing a plurality of user activity modes, a plurality of user interaction processes, and a plurality of geofenced activity zones managed by at least one remote server;
(B) providing a plurality of user profiles managed by the remote server, wherein each user profile includes personalized user data, location data, and user preference data, and wherein each user profile is associated to a corresponding user computing device;
(C) prompting to select at least one desired activity mode with a local computing device, wherein the desired activity mode is from the plurality of activity modes, wherein the local computing device is the user computing device associated to a local profile, and wherein the local profile is from the plurality of user profiles;
(D) gathering raw environmental data with the local computing device, wherein the raw environmental data includes current location data;
(E) determining if the local computing device is positioned within an active geofenced activity zone by comparing the current location data to the plurality of geofenced activity zones with the remote server, wherein the active geofenced activity zone is from the plurality of geofenced activity zones;
(F) generating a curated user group by comparing the personalized user data and the user preference data of each user profile with location data positioned within the active geofenced activity zone, with the remote server; and
(G) prompting to select at least one desired interaction process with the local computing device, wherein the desired interaction process is from the plurality of user interaction processes, and wherein the plurality of user interaction process includes, at least one user relations process, at least one vendor services process, and at least one activity modification process.

2. The method for facilitating venue-mediated social interactions as claimed in claim 1 comprising:
wherein the desired activity mode is an observer mode;
prompting to browse the curated user group with the local computing device;
preventing communication between the local profile and at least one remote profile with the remote server, wherein the remote profile is from the plurality of user profiles; and
selectively broadcasting the local profile to the curated user group with the local computing device.

3. The method for facilitating venue-mediated social interactions as claimed in claim 1 comprising:
wherein the desired activity mode is a participant mode;
prompting to browse the curated user group with the local computing device;
continually broadcasting the local profile to the curated user group with the local computing device; and
enabling communication between the local profile and the curated user group.

4. The method for facilitating venue-mediated social interactions as claimed in claim 1 comprising:
wherein the desired interaction process is the user relations process;
providing a plurality of networking operations managed by the remote server;
prompting to select at least one remote profile with the local computing device, wherein the remote profile is from the plurality of user profiles and is associated to a remote computing device;
prompting to select a desired networking operation with the local computing device; and
inviting the remote profile to participate in the desired networking operation with the remote server.

5. The method for facilitating venue-mediated social interactions as claimed in claim 1 comprising:
wherein the desired interaction process is the vendor services process;
providing a plurality of vendor profiles managed by the remote server, wherein each vendor profile includes a plurality of vendor services, location data, and vendor preference data, and wherein each vendor profile is associated to a corresponding vendor computing device;
generating a curated vendor group by comparing the personalized user data and the user preference data of the local account to the vendor service data and the vendor preference data of each vendor profile with location data positioned within the active geofenced activity zone, with the remote server;
prompting to select at least one desired service, at least one personal content, and at least one remote profile with the local computing device, wherein the desired service is from the plurality of vendor services included in the curated vendor group, and wherein the remote profile is from the plurality of user profiles;
generating a service voucher with the remote server, wherein the service voucher includes a service identifier and the personal content; and
prompting to redeem the service voucher with the remote computing device.

6. The method for facilitating venue-mediated social interactions as claimed in claim 5 comprising:
prompting to deliver the desired service with the vendor computing device.

7. The method for facilitating venue-mediated social interactions as claimed in claim 1 comprising:
wherein the raw environmental data includes visual-spatial data;
generating an interactive virtual reality (VR) environment using the location data of the local profile, the location data of the curated user group, the location data of a curated vendor group, and the visual-spatial data with the remote server; and
prompting to select at least one desired virtual object with the local computing device; wherein the desired virtual object is rendered within the interactive VR environment.
